(19) United States
(12) Patent Application Publication
(10) Pub. No.: US 2025/0196723 A1
(43) Pub. Date: Jun. 19, 2025

(54) FUEL CELL VEHICLE

(71) Applicant: TOYOTA JIDOSHA KABUSHIKI KAISHA, Aichi-ken (JP)

(72) Inventors: Ryohei TADA, Toyota-shi (JP); Rino OSHIKIRI, Toyota-shi (JP); Yuta KOBAYASHI, Toyota-shi (JP)

(21) Appl. No.: 18/977,934

(22) Filed: Dec. 12, 2024

(30) Foreign Application Priority Data
Dec. 18, 2023 (JP) 2023-212874

(51) Int. Cl. B60L 58/40; B60L 50/75; B60L 58/32

(52) U.S. Cl. CPC B60L 58/40; B60L 58/32; B60L 50/75; B60L 2240/545

(57) ABSTRACT

The vehicle rear structure comprises a travel motor; a fuel cell configured to output power to the travel motor; a battery configured to output power to the motor; and a controller, wherein the controller is configured to at least temporarily perform protection control to operate the battery at an output power higher than a rated output power during hill climbing traveling.

### CROSS REFERENCE TO RELATED APPLICATION

This application claims priority to Japanese Patent Application No. 2023-212874 filed on Dec. 18, 2023, which is incorporated herein by reference in its entirety including the specification, claims, drawings, and abstract.

### TECHNICAL FIELD

This specification discloses a fuel cell vehicle equipped with a fuel cell and a battery.

### BACKGROUND

Conventionally, a fuel cell vehicle having a fuel cell and a battery has been known. A controller mounted on the fuel cell vehicle controls the ratio of the output power of the fuel cell, the output power of the battery, and the regenerative power of the traveling motor according to the situation of the vehicle.

Patent Document 1 discloses such a fuel cell vehicle. The fuel cell vehicle of Patent Document 1 controls the ratio of the output power of the fuel cell to the entire output power to be larger when the start of the long-distance uphill is detected than before the start of the long-distance uphill is detected.

In the related art including Patent Document 1, the ratio of the output power of the fuel cell is set to be equal to or larger than the ratio of the output power of the battery during climbing. In this case, the amount of power generated by the fuel cell during climbing increases. When the amount of power generated by the fuel cell increases, the temperature of the fuel cell rises accordingly. When the temperature of the fuel cell exceeds a predetermined allowable value, the output power of the fuel cell is forcibly limited. As a result, in the related art, in the middle of the uphill travel, the electric power supplied to the travel motor may be insufficient, and the speed of the vehicle may decrease.

Therefore, the present specification discloses a fuel cell vehicle capable of suppressing a decrease in vehicle speed during climbing.

### CITATION LIST

PATENT DOCUMENT 1: JP.2012-244713.A

### SUMMARY

A fuel cell vehicle disclosed in this specification comprises, a travel motor; a fuel cell configured to output power to the travel motor; a battery configured to output power to the motor; and a controller, wherein the controller is configured to at least temporarily perform FC protection control to operate the battery at an output power higher than a rated output power during hill climbing traveling.

By temporarily increasing the output power of the battery, the temperature rise of the fuel cell can be suppressed. As a result, it is possible to avoid limitation of the output power of the fuel cell, and it is possible to effectively suppress a decrease in the vehicle speed due to insufficient power.

In this case, the controller may be configured to perform the FC protection control when detecting start of hill climbing traveling, to reduce an output power of the battery after a predetermined period of time, and to increase an output power of the fuel cell in conjunction with the reduction of the output power of the battery.

By increasing or decreasing the output power of the battery and the output power of the fuel cell in conjunction with each other, the output power value of the vehicle as a whole can be stabilized.

Further, the controller may be configured to cause the battery to output power within a prescribed battery output power upper limit value and to cause the fuel cell to output the deficient output power, and the controller may be configured to set the battery output power upper limit value to be higher than the rated output power of the battery in the FC protection control.

By setting the upper limit value of the battery output power of the battery, it is possible to prevent the output power of the battery from becoming excessively high.

Further, the controller may be configured to start the FC protection control when a temperature of a cooling water of the fuel cell reaches a prescribed threshold temperature during the hill climbing traveling.

With such a configuration, it is possible to effectively prevent the output power of the fuel cell from being forcibly limited, and it is possible to effectively suppress a decrease in the vehicle speed due to insufficient power.

Further, the controller may be configured to terminate the FC protection control when a prescribed relaxation time ta has elapsed after the FC protection control is started, a temperature of the battery has exceeded a prescribed threshold, or a SOC of the battery has fallen below a prescribed threshold.

With this configuration, deterioration of the battery can be effectively prevented.

According to the fuel cell vehicle disclosed in this specification, it is possible to effectively suppress a decrease in vehicle speed during hill climbing traveling.

### BRIEF DESCRIPTION OF DRAWINGS

Embodiment(s) of the present disclosure will be described based on the following figures, wherein:

FIG. 1 is a block diagram showing a configuration of an FC vehicle;

FIG. 2 is a diagram showing changes in altitude, battery output power, FC output power, FC water temperature, and vehicle speed when hill climbing traveling is performed in the FC vehicle;

FIG. 3 is a diagram showing another example of changes in altitude, battery output power, FC output power, FC water temperature, and vehicle speed when hill climbing traveling is performed in the FC vehicle;

FIG. 4 is a flowchart showing a flow of power control in hill climbing traveling of the FC vehicle; and

FIG. 5 is a diagram showing changes in altitude, battery output power, FC output power, FC water temperature, and vehicle speed when hill climbing traveling is performed in the FC vehicle of the comparative example.

### DESCRIPTION OF EMBODIMENT

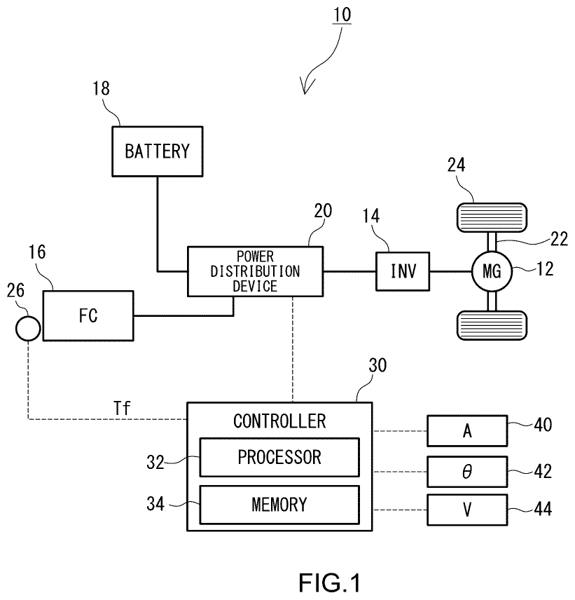

Hereinafter, a configuration of the fuel cell vehicle 10 will be described with reference to the drawings. Hereinafter, the “fuel cell” is abbreviated as “FC”. FIG. 1 is a block diagram illustrating a configuration of an FC vehicle 10. As shown in FIG. 1, the FC vehicle 10 mainly includes, as drive systems, a traveling motor 12, an FC unit 16, a battery 18, a transmission 22, and wheels 24.

The traveling motor 12 is a motor generator that generates traveling power based on supplied electric power and generates regenerative power by braking force of the vehicle. The power of the traveling motor 12 is transmitted to the wheels 24 via the transmission 22. The wheels 24 are rotated by the power, so that the FC vehicle 10 travels. The inverter 14 converts DC power into AC power and supplies the AC power to the traveling motor 12. The inverter 14 converts the regenerative power output from the traveling motor 12 into DC power and outputs the DC power to the battery 18.

The FC unit 16 is a device that generates electric power by utilizing an electrochemical reaction between hydrogen and oxygen. The FC unit 16 has an FC stack, and the FC stack is configured by stacking a plurality of FC cells. The FC cell is formed, for example, by sandwiching a solid polymer electrolyte membrane between an anode electrode and a cathode electrode from both sides. The electric power generated by the FC unit 16 is supplied to the traveling motor 12 and the battery 18.

Here, the FC unit 16 generates heat due to power generation. When the temperature of the FC unit 16 becomes excessively high, the FC unit 16 deteriorates or is damaged. Therefore, the FC unit 16 is provided with a cooling circuit (not shown) through which cooling water flows, and the FC unit 16 is cooled by the cooling water. The FC unit 16 is provided with a temperature sensor 26 that detects the temperature of the cooling water. Hereinafter, the temperature of the cooling water detected by the temperature sensor 26 is referred to as an “FC water temperature Tf”.

The battery 18 is an energy storage capable of charging and discharging electric power. The battery 18 is, for example, a lithium ion secondary battery, a nickel metal hydride battery, a capacitor, or a combination thereof. The voltage and current of the battery 18 are detected by a sensor (not shown). The controller 30 calculates the remaining capacity of the battery 18, that is, the SOC, based on the detected voltage and current.

The power distribution device 20 controls a supply destination of the output power of the FC unit 16, the output power of the battery 18, and the regenerative power of the traveling motor 12. The power distribution device 20 is, for example, a DC/DC converter.

The controller 30 controls the traveling motor 12, the inverter 14, the FC unit 16, the battery 18, and the power distribution device 20. The controller 30 is physically a computer having a processor 32 and a memory 34. In FIG. 1, the controller 30 is illustrated as a single computer, but the controller 30 may be configured by combining a plurality of computers physically separated from each other.

Further, the FC vehicle 10 includes a plurality of sensors. The opening degree sensor 42 detects the opening degree of the accelerator pedal, that is, the accelerator opening degree θ. The gradient sensor 40 detects the gradient A of the road surface (i.e., the inclination of the vehicle 10 in the front-rear direction). The gradient sensor 40 is, for example, a gravity sensor. The vehicle speed sensor 44 detects the vehicle speed V. The controller 30 calculates, as the required output power PR, the output power necessary to cause the vehicle to travel based on the detection values of these sensors. Then, the controller 30 controls the driving of the FC unit 16 and the battery 18 so that the required output power PR is supplied to the traveling motor 12.

Here, the upper limit value of the output power, that is, the battery output power upper limit value PBmx is set in advance in the battery 18. The controller 30 controls the driving of the battery 18 so that the battery output power PB does not exceed the battery output power upper limit value PBmx. The battery output power upper limit value PBmx is normally a power value at which the battery 18 can be continuously and stably operated, that is, the rated output power PB*. In this example, when the FC vehicle 10 performs hill climbing traveling, the battery output power upper limit value PBmx is temporarily set to a value higher than the rated output power PB*, which will be described later.

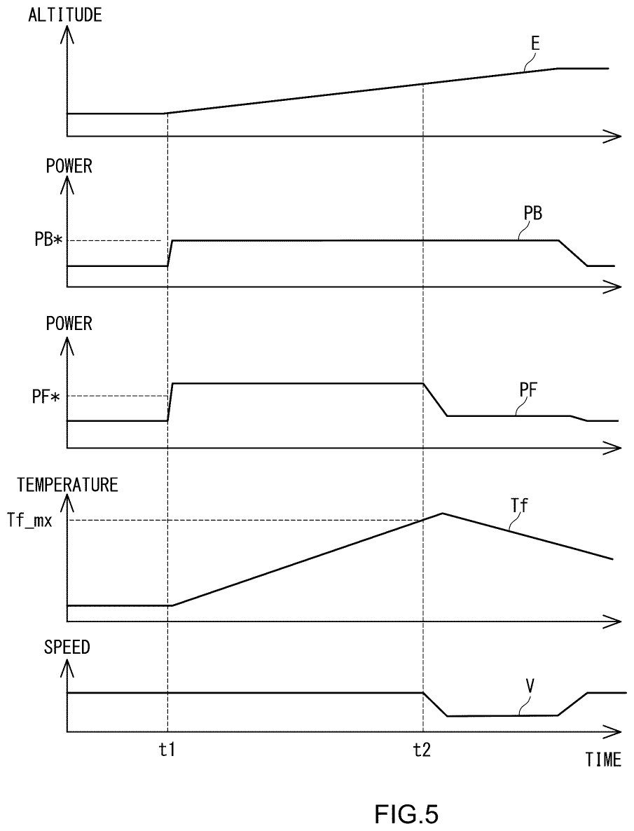

Here, in the case where the FC vehicle 10 performs hill climbing traveling, the required output power PR increases as compared with the case where the vehicle travels on a flat surface. When the output power of both the battery 18 and the FC unit 16 is increased in order to satisfy the required output power PR, there is a possibility that the power generation capability of the FC unit 16 is limited in the middle of the hill climbing traveling. This will be described with reference to FIG. 5.

FIG. 5 is a graph showing changes in altitude E, battery output power PB, FC output power PF, FC water temperature Tf, and vehicle speed V when hill climbing traveling is performed in the FC vehicle of the comparative example. In the example of FIG. 5, the FC vehicle starts entering an uphill slope at time t1.

By entering the uphill, the required output power PR increases. In order to obtain the required output power PR, the FC vehicle of the comparative example drives the battery 18 within the range of the battery output power upper limit value PBmx (that is, the rated output power PB*), and causes the FC unit 16 to output insufficient power. In this case, the output power of the FC unit 16 often exceeds the rated output power PF* of the FC unit 16, although it varies depending on the vehicle speed V and the gradient A. As a result, the temperature of the cooling water for cooling the FC unit 16, that is, the FC water temperature Tf may reach the FC water temperature allowable value Tf_mx in the middle of the hill climbing traveling. In the case of FIG. 5, at time t2, the FC water temperature Tf reaches the FC water temperature allowable value Tf_mx.

When Tf≥Tf_mx, the controller 30 lowers the FC output power PF in order to lower the FC water temperature Tf. When the FC output power PF decreases, the electric power that can be used in the entire vehicle decreases, leading to a decrease in the vehicle speed V.

In order to prevent a decrease in the vehicle speed V in the middle of the hill-climbing traveling, the FC vehicle 10 disclosed herein at least temporarily executes the FC protection control during the execution of the hill-climbing traveling. The FC protection control is control for operating the FC unit 16 with output power equal to or lower than the rated output power PF* while operating the battery 18 with output power higher than the rated output power PB*. Hereinafter, power control for hill climbing traveling in the FC vehicle 10 disclosed herein will be described in detail.

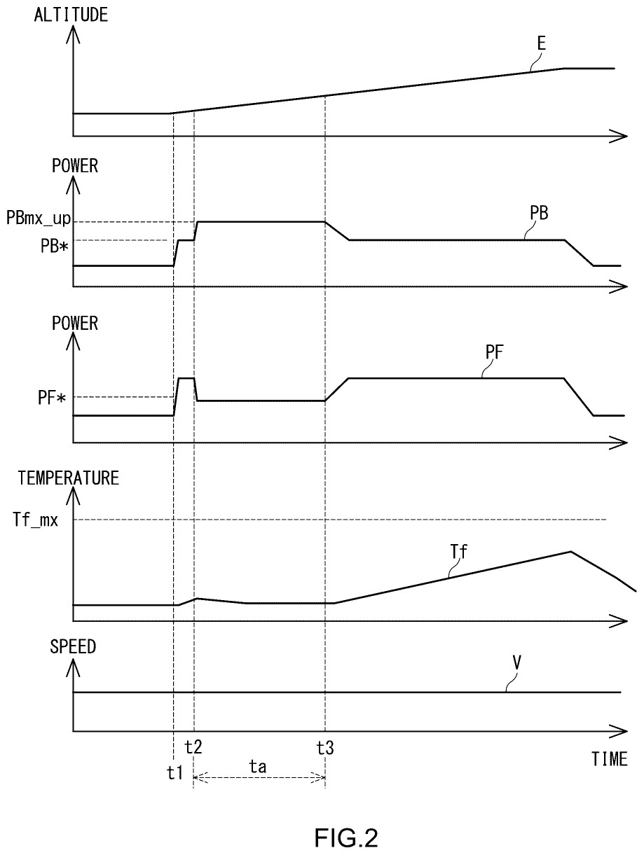

FIG. 2 is a diagram showing changes in altitude E, battery output power PB, FC output power PF, FC water temperature Tf, and vehicle speed V when hill climbing traveling is performed in the FC vehicle 10 disclosed in the present specification. Before the start of the hill climbing traveling, the battery output power upper limit value PBmx is the same value as the rated output power PB* of the battery 18. When hill climbing traveling is started at time t1, the required output power PR increases. In order to obtain the required output power PR, the controller 30 controls the driving of the battery 18 and the FC unit 16 so as to increase the battery output power PB within the range of the battery output power upper limit value PBmx=PB* and compensate for the shortage with the FC output power PF. As a result, immediately after time t1, both the battery output power PB and the FC output power PF temporarily increase.

Here, when the FC output power PF continues to be high, as described above, the FC water temperature Tf rises to the FC water temperature allowable value Tf_mx, and the output power limitation of the FC unit 16 occurs. Therefore, in the present example, when the controller 30 detects the start of the hill climbing traveling, the battery output power PB is temporarily set to be higher than the rated output power PB*, and FC protection control for suppressing the FC output power PF to be small is executed.

For example, in the example of FIG. 2, it is assumed that the controller 30 detects the start of hill climbing traveling at time t2. In this case, the controller 30 starts FC protection control for temporarily changing the battery output power upper limit value PBmx to the battery output power relaxation upper limit value PBmx_up higher than the rated output power PB*. As a result, the battery output power PB rises to the battery output power relaxation upper limit value PBmx_up. When the battery output power PB increases, the FC output power PF decreases accordingly.

Note that the controller 30 may determine that hill climbing traveling is being performed, for example, when the gradient A is equal to or greater than a prescribed threshold and the vehicle speed V is equal to or greater than a prescribed threshold. As another form, the controller 30 may determine whether or not the hill climbing traveling is being executed by comparing the current position detected by the GPS with the map information registered in the navigation system.

As a matter of course, if the state in which the battery output power PB exceeds the rated output power PB* continues for a long period of time, a problem such as a decrease in the life of the battery 18 occurs. On the other hand, if the state of exceeding the rated output power PB* is a short period of time, there is little adverse effect on the battery 18. In the present example, focusing on such characteristics, when hill climbing traveling is started, the battery output power upper limit value PBmx is set to be higher than the rated output power PB* only for a predetermined relaxation time ta.

As a result, the battery output power PB becomes higher than the rated output power PB* and the FC output power PF decreases between the time t2 at which the start of the hill-climbing traveling is detected and the time t3 at which the relaxation time ta elapses. As a result, an increase in the FC water temperature Tf is suppressed.

Thereafter, at time t3 when the relaxation time ta has elapsed, the controller 30 decreases the battery output power upper limit value PBmx from the battery output power relaxation upper limit value PBmx_up to the rated output power PB*. As a result, the battery output power PB decreases to the rated output power PB*. In addition, the FC output power PF increases in conjunction with a decrease in the battery output power PB. As the FC output power PF increases, the FC water temperature Tf also gradually increases. However, since the FC protection control for operating the battery 18 with high output power is executed in advance, the rise start timing of the FC water temperature Tf in the present example is later than the rise start timing in FIG. 5. As a result, there is a high probability that the hill climbing traveling can be completed before the FC water temperature Tf reaches the FC water temperature allowable value Tf_mx. As a result, it is possible to effectively suppress the decrease in the vehicle speed V due to the power shortage in the middle of the hill climbing traveling.

The battery output power relaxation upper limit value PBmx_up is not particularly limited as long as it is higher than the rated output power PB*, but is, for example, 1.2 times, 1.5 times, or 2 times the rated output power PB*. For example, the battery output power relaxation upper limit value PBmx_up may be the same value as the maximum output power of the battery 18. The battery output power relaxation upper limit value PBmx_up may be a predetermined fixed value or a variable value that varies according to conditions. The relaxation time ta is not limited as long as it is larger than 0, and is, for example, several seconds, several ten seconds, or several minutes. The relaxation time ta may be a predetermined fixed value or a variable value that varies depending on conditions. Further, in the present example, the end timing of the FC protection control is determined based on the elapsed time, but the end timing of the FC protection control may be determined based on other parameters. For example, when the FC protection control is started, the controller 30 may detect the temperature or the SOC of the battery 18 and terminate the FC protection control when the temperature exceeds a prescribed threshold or when the SOC falls below the prescribed threshold.

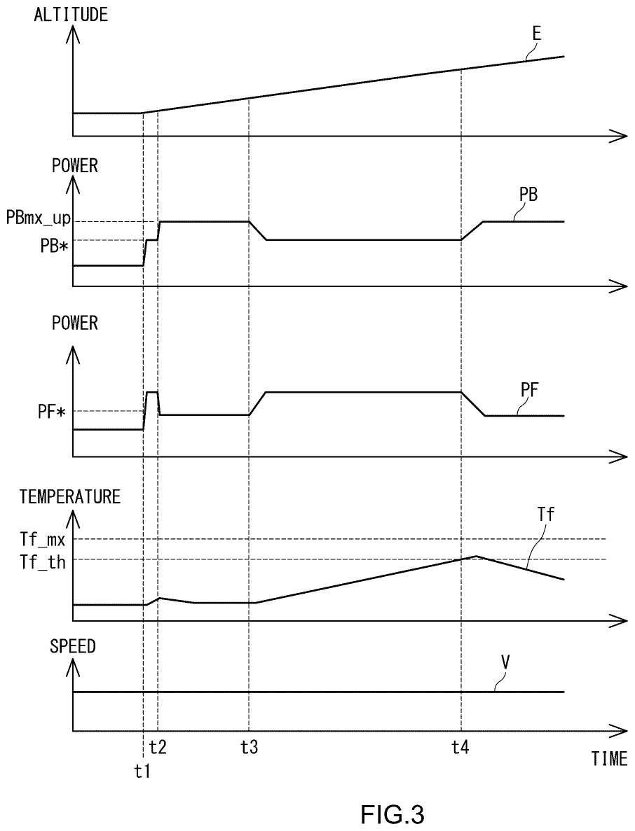

In FIG. 2, the FC protection control is executed only immediately after the start of the hill climbing traveling. However, when the vehicle travels on a long uphill, the FC protection control may be executed a plurality of times at intervals. For example, in the example of FIG. 3, after the first FC protection control is ended at time t3, the water temperature of the FC water temperature Tf gradually increases as the FC output power PF increases. Then, it is assumed that the FC water temperature Tf reaches the prescribed threshold temperature Tf_th at time t4 before the end of the climbing. Note that Tf_th≤Tf_mx. In this case, the controller 30 may restart the FC protection control for setting the battery output power upper limit value PBmx to be higher than the rated output power PB*. By restarting the FC protection control, it is possible to effectively avoid the forced output power limitation of the FC unit 16, and it is possible to suppress the power shortage and thus the decrease in the vehicle speed V. Further, by restarting the FC protection control, the output power of the FC unit 16 is suppressed, and the FC water temperature Tf gradually decreases. In order to protect the battery 18, the start of the (n+1)th FC protection control may be prohibited until a specified standby time elapses or until the temperature of the battery 18 becomes equal to or lower than a specified threshold value after the nth FC protection control is ended.

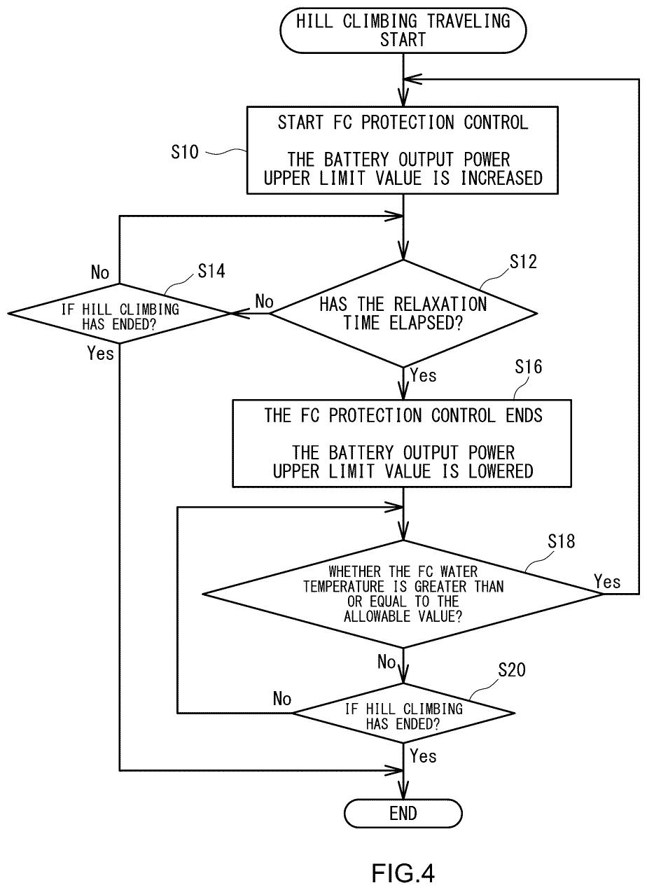

FIG. 4 is a flowchart showing a flow of power control in hill climbing traveling of the FC vehicle 10 of the present example. As shown in FIG. 4, when the hill climbing traveling is started, the controller 30 starts the FC protection control (S10). That is, the controller 30 sets the battery output power upper limit value PBmx to the battery output power relaxation upper limit value PBmx_up higher than the rated output power PB*. As a result, while the battery output power PB becomes higher than the rated output power PB*, the FC output power PF decreases, and an increase in the FC water temperature Tf is suppressed.

The FC protection control is continued until the specified relaxation time ta elapses. When the relaxation time ta has elapsed (Yes in S12), the controller 30 ends the FC protection control (S16). That is, the controller 30 lowers the battery output power upper limit value PBmx to the rated output power PB*. As a result, the battery output power PB decreases, and the FC output power PF increases accordingly.

Thereafter, the controller 30 monitors the FC water temperature Tf (S18). When the FC water temperature Tf becomes equal to or higher than the FC water temperature allowable value Tf_mx (Yes in S18), the controller 30 returns to step S10 and restarts the FC protection control. Thereafter, the same processing is repeated until the hill climbing traveling ends.

As is clear from the above description, according to the technology disclosed in the present specification, since it is possible to suppress the temperature rise of the FC water temperature Tf, it is possible to effectively suppress the decrease in the vehicle speed V due to the limitation of the output power of the FC unit 16 in the middle of the hill climbing traveling, that is, the power shortage. The above-described configuration is merely an example, and other configurations may be appropriately changed as long as the configuration described in claim 1 is provided. For example, in the above description, the FC protection control is executed immediately after the hill climbing traveling is detected. However, the start timing of the FC protection control may be shifted later. That is, even after the hill climbing traveling is detected, normal control may be performed, and the FC protection control may be started after the FC water temperature Tf reaches a predetermined temperature.

### REFERENCE SIGNS LIST

10 FC vehicle, 12 traveling motor, 14 inverter, 16 FC unit, 18 battery, 20 power distribution device, 22 transmission, 24 wheel, 26 temperature sensor, 30 controller, 32 processor, 34 memory, 40 gradient sensor, 42 opening degree sensor, 44 vehicle speed sensor.

1. A fuel cell vehicle comprising:
a travel motor;
a fuel cell configured to output power to the travel motor;
a battery configured to output power to the motor; and
a controller,
wherein the controller is configured to at least temporarily perform FC protection control to operate the battery at an output power higher than a rated output power during hill climbing traveling.

2. The fuel cell vehicle according to claim 1, wherein
the controller is configured to perform the FC protection control when detecting start of hill climbing traveling, to reduce an output power of the battery after a predetermined period of time, and to increase an output power of the fuel cell in conjunction with the reduction of the output power of the battery.

3. The fuel cell vehicle according to claim 1, wherein
the controller is configured to cause the battery to output power within a prescribed battery output power upper limit value and to cause the fuel cell to output the deficient output power, and
the controller is configured to set the battery output power upper limit value to be higher than the rated output power of the battery in the FC protection control.

4. The fuel cell vehicle according to claim 1, wherein
the controller is configured to start the FC protection control when a temperature of a cooling water of the fuel cell reaches a prescribed threshold temperature during the hill climbing traveling.

5. The fuel cell vehicle according to claim 1, wherein
the controller is configured to terminate the FC protection control when a prescribed relaxation time ta has elapsed after the FC protection control is started, a temperature of the battery has exceeded a prescribed threshold, or a SOC of the battery has fallen below a prescribed threshold.
